(19) United States
(12) Patent Application Publication
(10) Pub. No.: US 2003/0055616 A1
(43) Pub. Date: Mar. 20, 2003

(54) Electromagnetic field simulation method as well as a system and recording medium for the same

(76) Inventor: Shinichi Hayashi, Tokyo (JP)

Correspondence Address: KENYON & KENYON, 1500 K STREET, N.W., SUITE 700, WASHINGTON, DC, 20005, US

(21) Appl. No.: 10/234,173

(22) Filed: Sep. 5, 2002

(30) Foreign Application Priority Data
Sep. 5, 2001 (JP) 2001-268356

(51) Int. Cl. G06F 17/10

(52) U.S. Cl. 703/2

(57) ABSTRACT

The invention relates to an electromagnetic field simulation method that uses a reduced number of sampling points and is less affected by errors due to areading, a system using the same, and a recording medium having a program for the same recorded therein. In the electromagnetic field simulation method for calculating from an electric or magnetic field sampled in an aperture 3 an electric or magnetic field at a different site, sampling points are collocated according to a collocating rule having non-translation symmetry.

This application claims benefit of Japanese Application No. 2001-268356 filed in Japan on Sep. 5, 2001, the contents of which are incorporated by this reference.

### BACKGROUND OF THE INVENTION

The present invention relates generally to an electromagnetic field simulation method, a calculating system using the method, and a recording medium having a simulation program recorded therein for implementing the method on the calculating system. More specifically, this invention is -concerned with an electromagnetic field simulation method for finding the distribution of an electric or magnetic field on a certain aperture and calculating therefrom an electric or magnetic field on a spatial point other than that aperture, a calculating system using the method, and a recording medium having a simulation program recorded therein for implementing the method on the calculating system.

As set forth typically in M. Born and E. Wolf, “Principles of Optics, Sixth Edition”, Pergamon Press (1980), Chapter X, and Tokuhisa Ito, “Optics for Steppers (1) to (4)”, Optical Technology Contact, Vol. 27 (1989), pp. 762-771 and Vol. 28 (1990), pp. 59-67, 108-119 and 165-175, methods by imaging theories on the basis of the so-called Fourier optics have already been known for the calculation of images including illumination light for microscopes, steppers, etc. When calculating images on the basis of Fourier optics, the product of the entrance electric field distribution Eₚ on the entrance pupil plane of an image-formation optical system and the pupil function P of the image-formation optical system is subjected to a Fourier transform on the basis of the following formula (1), thereby calculating the electric field distribution Eₒ on the focal plane.

$$Eo ( x , y ) = A \int {\int }_{s} Ep ( ξ , η ) P ( ξ , η ) exp [ \frac{j 2 π}{λ f} ( x ξ + y η ) ] ⅆ ξ ⅆ η \qquad ( 1 )$$

Here x and y represent two-dimensional coordinates on the image plane, S the entrance pupil plane, ξ and η two-dimensional coordinates on the entrance pupil plane of the image-formation optical system, A a proportional coefficient, j a unit imaginary number, λ the wavelength of incident light, and f the focal length of the image-formation optical system. Integration is performed all over the aperture of the entrance pupil plane of the image-formation system.

In general, the integral of formula (1) cannot be solved analytically, and so numerical integration is used. In numerical integration, the domain of integration is sampled due to a limitations to the amount of data to be dealt with. In other words, the domain of integration is divided into minute sub-domains to obtain the total sum of the product of the value of integrand on the coordinates representative of each minute sub-domain and the area of each minute sub-domain for approximation of integration. An electric field Eₒ^{s} on a focal plane, calculated by sampling, is found from the following formula (2):

$${Eo}^{s} ( x , y ) = A {\sum }_{n} Ep ( {ξ}_{n} , {μ}_{n} ) P ( {ξ}_{n} , {μ}_{n} ) exp [ \frac{j 2 π}{λ f} ( x {ξ}_{n} + y {η}_{n} ) ] δ {S}_{n} \qquad ( 2 )$$

Here n is the serial No. of a minute sub-domain, ξₙ and ηₙ are the two-dimensional coordinates on the entrance pupil, representative of the n-th minute sub-domain, and δSₙ is the area of the n-th minute sub-domain.

For the numerical calculation of Fourier integrals, it has so far been general to use a fast Fourier transform (FFT), as set forth typically in JP-A 09-89720. Of FFT calculus, no account is now given because it has already been described in a number of textbooks. When such a two-dimensional Fourier transform as mentioned above is calculated according to FFT, the range of integration is divided into a tetragonal lattice form for sampling.

However, this conventional method has the following demerit. For the numerical calculation of Fourier integrals using a tetragonal lattice form of sampling such as FFT, as many sampling points as possible must be taken to avoid errors due to aliasing and so much calculation time is often taken as detailed below.

An electric field distribution Eₒ^{q} on a focal plane, calculated using a tetragonal lattice form of sampling, is found from the following formula (3):

$$\begin{matrix}{Eo}^{q} ( x , y ) = A {\sum }_{n} Ep ( n Δξ , n Δ η ) P ( n Δξ , n Δ η ) \\ exp [ \frac{j 2 π}{λ f} ( x n Δ ξ + y n Δ {η}_{n} ) ] Δ ξ Δ η \\ = A \int {\int }_{s} Ep ( ξ , η ) P ( ξ , η ) III ( \frac{ξ}{Δ ξ} ) III ( \frac{η}{Δ η} ) \\ exp [ \frac{j 2 π}{λ f} ( x ξ + y η ) ] ⅆ ξ ⅆ η \\ = Eo ( x , y ) ⊗ \{ III ( Δ ξ x ) III ( Δ η y ) Δ ξΔ η \} \\ = Eo ( x , y ) + {\sum }_{n \neq 0} Eo ( x - \frac{λ f}{Δ ξ} n , y - \frac{λ f}{Δ η} n )\end{matrix} \qquad ( 3 )$$

Here Δξ and Δη are the lattice constants of sampling in the ξ and η directions, respectively, and the formula (4)

$$III ( z ) ≡ {\sum }_{n} δ ( z - n ) \qquad ( 4 )$$

is a function called a comb function. The encircled × operator is a convolution operator having with respect to any function f(z) the following relation:

f(z)\mathring{×}δ(z−zₒ)≡f(z−zₒ) (5)

The rightmost second term of formula (3) stands for errors due to aliasing This aliasing represented by formula (3) takes a form wherein right values Eₒ are repetitively collocated at a space (λf/Δξ, λf/Δη) in the x- and y-axis directions. Regular repetition of the right values allows this aliasing to have strong directivity, causing the symmetry that the right values Eₒ have to be considerably out of order.

To reduce calculation errors due to this aliasing the lattice constants Δξ, Δη of sampling must be made small so that the individual components of aliasing can be spaced farther enough from Eₒ to avoid their influence on Eₒ.

However, the decreases in the lattice constants Δξ, Δη result inevitably in an increase in the number of sampling points, and so the amount of calculation increases in proportion to that increase. It follows that to reduce errors due to aliasing much calculation time is needed.

### SUMMARY OF THE INVENTION

Having been accomplished in view of such problems with the prior art, the object of the invention is to provide an electromagnetic field simulation method that is less affected by errors due to aliasing and can be performed with a reduced number of sampling points, a system using the same, and a recording medium having a simulation program recorded therein for implementing the same on a calculating machine.

According to the present invention, this object is achieved by the provision of an electromagnetic field simulation method for calculating an electric or magnetic field at a different site from an electric or magnetic field sampled in an aperture, characterized in that sampling points are collocated according to a collocating rule having non-translation symmetry.

The present invention also provides an electromagnetic field simulation system for calculating an electric or magnetic field at a different site from an electric or magnetic field sampled in an aperture characterized in that sampling points are collocated according to a collocating rule having non-translation symmetry.

Moreover, the present invention provides a recording medium having an image-formation or electromagnetic field simulation program recorded therein for allowing a calculating machine to calculate an electric or magnetic field at a different site from an electric or magnetic field sampled in an aperture, characterized in that sampling points are collocated according to a collocating rule having non-translation symmetry.

Still other objects and advantages of the invention will in part be obvious and will in part be apparent from the specification.

The invention accordingly comprises the features of construction, combinations of elements, and arrangement of parts, which will be exemplified in the construction hereinafter set forth, and the scope of the invention will be indicated in the claims.

### BRIEF DESCRIPTION OF THE DRAWINGS

FIG. 1 is illustrative of a calculation mode for the first embodiment of the electromagnetic simulation method of the invention.

FIG. 2 is illustrative of how sampling points are collocated according to the first embodiment of the sampling method of the invention.

FIG. 3 is illustrative of how sampling points are collocated in a conventional sampling method corresponding to the first embodiment.

FIGS. 4(a) to 4(c) show the results of calculation by the first embodiment as compared with those by the conventional sampling method.

FIG. 5 is illustrative of how sampling points are collocated according to the second embodiment of the invention.

FIG. 6 is illustrative of how sampling points are collocated in a conventional sampling method corresponding to the second embodiment.

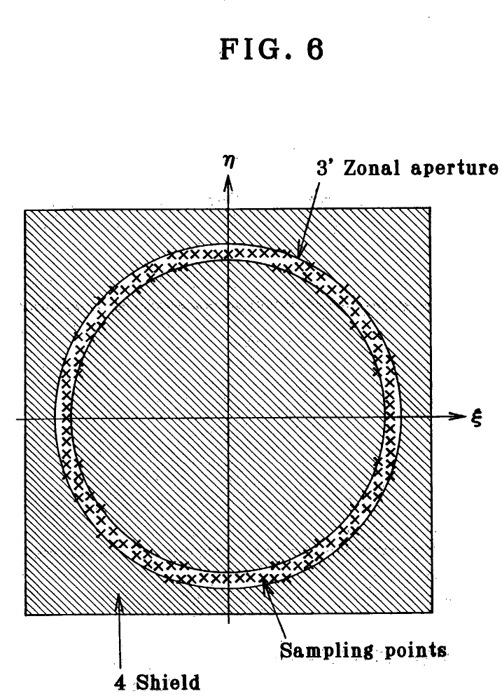

FIGS. 7(a) to 7(c) show the results of a calculation by the second embodiment as compared with those by the conventional sampling method.

FIG. 8 is a flowchart indicating simulation steps in the simulation means of the first embodiment.

### DESCRIPTION OF THE PREFERRED EMBODIMENTS

First, embodiments of the electromagnetic field simulation method of the invention, with which the aforesaid object is achievable, and the system and recording medium for implementing the same will be explained with their respective advantages. Then, appropriate constructions that may be added to the invention will be explained with their advantages. Finally, examples of the method, system and recording medium will be given.

The present invention provides an electromagnetic field simulation method for sampling an electric or magnetic field from within a certain aperture to calculate therefrom an electric or magnetic field at a different site. This method is characterized in that sampling points are collocated according to a collocating rule having non-translation symmetry.

According to this method wherein the collocation of sampling points does not contain any translation symmetry that is responsible for aliasing having strong directivity, calculation errors can be kept so relatively low that the desired calculation precision can be obtained with a reduced number of sampling points, resulting in reductions in calculation time.

In one preferable embodiment of the invention, the sampling points are characterized by being collocated on concentric circles of equidistant radii.

With this embodiment wherein the sampling points are concentrically collocated, it is easy to eliminate translation symmetry and keep aliasing low. Furthermore, when the instant embodiment is applied to the calculation of a diffraction field due to a circular aperture, it is possible to make short calculation time because there are obtained the results of calculation approximate to rotational symmetry with respect to the diffraction field that should by definition have rotationally symmetry, using a relatively reduced number of sampling points.

Another preferable embodiment of the invention is characterized in that the sampling points are equally spaced and collocated on concentric circles with the number of division proportional to the radii of those concentric circles.

According to the instant embodiment wherein the sampling points are equally spaced and collocated on concentric circles with the number of division proportional to the radii of those concentric circles, the spaces between the sampling points are kept substantially constant on all of the concentric circles. This is preferable in view of calculation precision of numerical integration.

Yet another preferable embodiment of the invention is characterized in that the sampling points are distributed on concentric circles at a space substantially equal to a distance from a concentric circle to one adjacent thereto.

The instance embodiment, wherein the sampling points are distributed on concentric circles at a space substantially equal to a distance from a concentric circle to one adjacent thereto, is preferable in view of calculation precision of numerical integration because the sampling points are substantially uniformly distributed.

A further preferable embodiment of the invention is characterized in that the sampling points are equally spaced and distributed on concentric circles in a multiple of 6.

The instant embodiment, wherein the sampling points are equally spaced and distributed on concentric circles in a multiple of 6, is preferable in view of calculation precision of numerical integration, because the sampling points are uniformly distributed from the center to the periphery of the aperture at a substantially uniform density.

The electromagnetic field simulation system of the invention is operated the ways explained with reference to the aforesaid embodiments.

In the recording medium of the invention wherein an electromagnetic field simulation program is recorded, there is recorded an image-formation simulation program for implementing the method as embodied above on a calculating machine.

The system and recording medium of the invention have the same advantages as explained with reference to each of the aforesaid embodiments.

The electromagnetic field simulation method of the invention and the system and recording medium for the same are now explained with reference to the accompanying drawings.

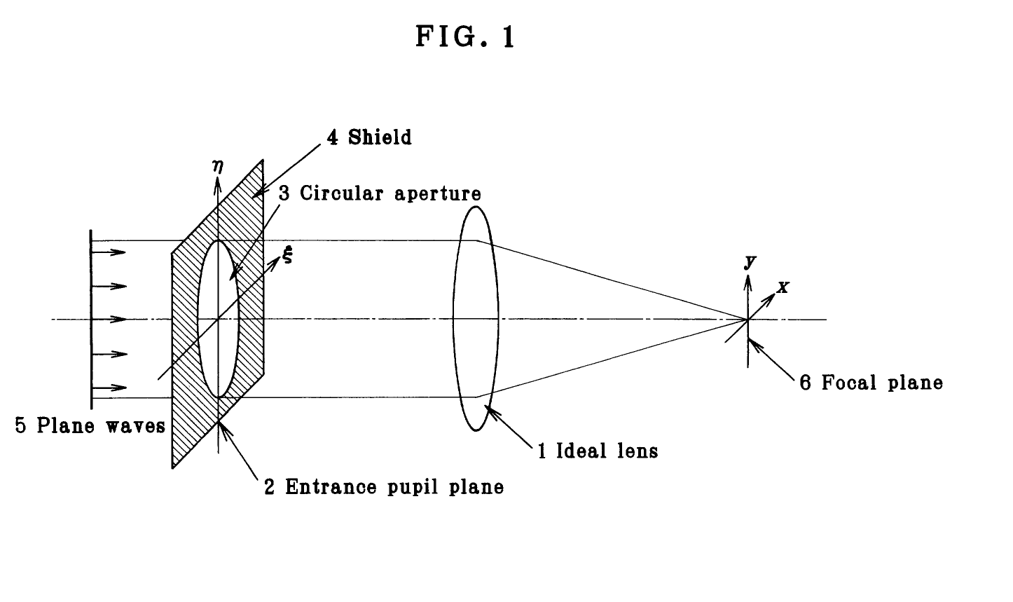

The electromagnetic field simulation method of the invention is applied to the calculation of a diffraction pattern at a focal plane 6 when, as shown in FIG. 1, plane waves are entered into an ideal lens 1 having a circular aperture 3 of radius po formed in a cutoff portion 4 located at an entrance pupil plane 2. As the plane waves 5 are incident on the entrance pupil plane 2, the wave fronts are cut out in a circular form by the circular aperture 3 at the entrance pupil plane 2, forming a diffraction pattern at the focal plane 6 through the ideal lens 1.

Here assume that the incident plane waves 5 have a uniform amplitude of 1 at the entrance pupil plane 3 and the ideal lens 1 is free from aberrations. Then, the pupil function P of the ideal lens 1 is given by

$$\begin{matrix}P ( ξ , η ) = 1 , & ( {ξ}^{2} + {η}^{2} \leq {ρ}_{o}^{2} ) \\ = 0 , & ( else )\end{matrix} \qquad ( 6 )$$

Thus, the diffraction pattern at the focal plane 6 should be rotationally symmetric with respect to an optical axis, because the incident wave fronts 5 and image-formation optical system 1 are rotationally symmetric with respect to the optical axis.

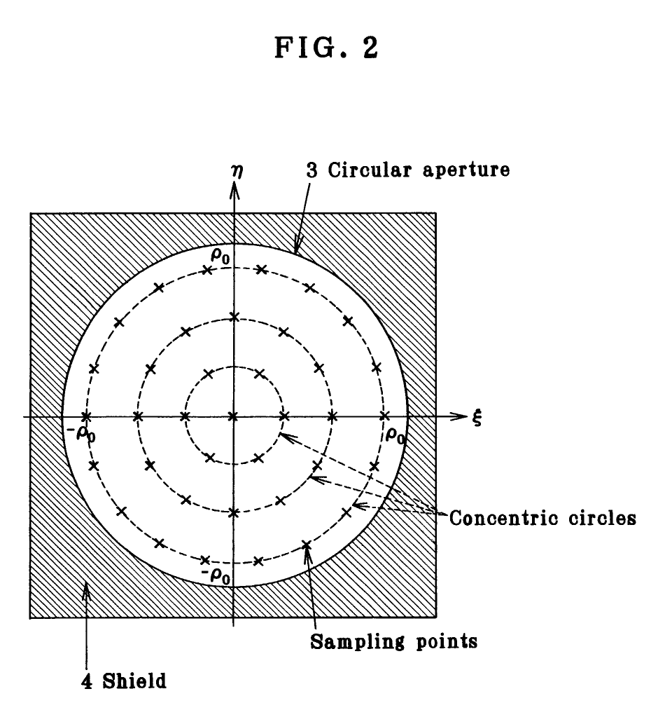

In accordance with the sampling method of the invention, the sampling points are equally spaced on the concentric circles whose centers are in alignment with the center of the circular aperture 3 of the entrance pupil in such a way that the number of the sampling points increases in order from the innermost concentric circle in a multiple of 6, i.e., from 6 to 12 and then 18, as shown by symbols × in FIG. 2, so that the density of the sampling points are made generally uniform. In addition, one sampling point is located on the optical axis that is the center of the concentric circles. However, it is noted that only this sampling point has a weight of ¾ of that of other sampling point.

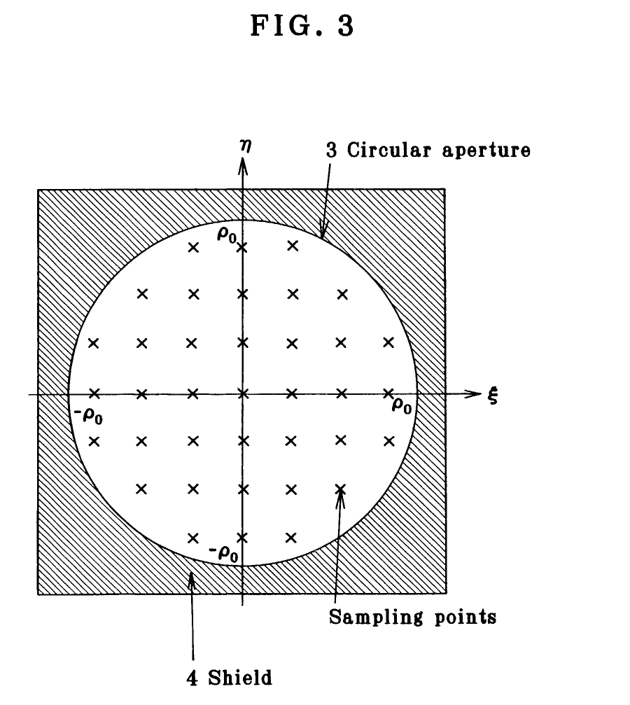

According to a conventional sampling method, on the other hand, sampling points are collocated within a circular aperture 3 at an entrance pupil plane in a tetragonal lattice form, as shown in FIG. 3.

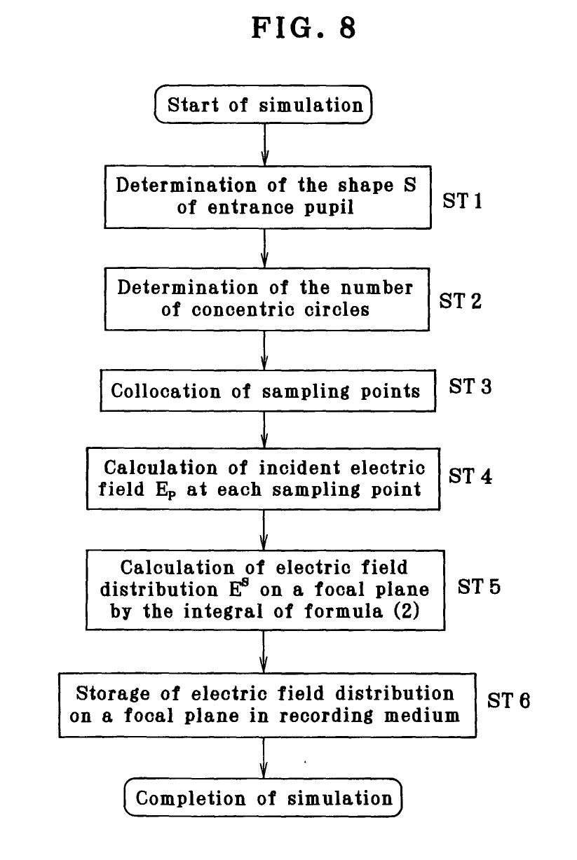

According to the simulation means of the instant embodiment, as shown in FIG. 8, the shape S of the entrance pupil (circular aperture) is first determined at step ST1. Then, at step ST2, the number of concentric circles on which sampling points are to be collocated is determined. Then, at step ST3, the sampling points are collocated. Then, at step ST4, an incident electric field Eₚ at each sampling point is calculated (a constant herein). Then, at step ST5, an electric field distribution E^{s} at a focal plane is calculated on the basis of integration formula (2). Finally, at step ST6, the found electric field distribution at the focal plane is stored in a recording medium. In this way, simulation is completed.

In the instant embodiment, it is noted that a diffraction pattern Eₒ to be formed at a focal plane 6 may be analytically solved. With the omission of the proportional constant for the sake of simplification, we obtain from formula (1)

$$\begin{matrix}{E}_{o} ( x , y ) = {\int \int }_{{ξ}^{2} + {η}^{2} <= {ρ}_{o}^{2}} exp [ \frac{j 2 π}{λ f} ( x ξ + y η ) ] ⅆ ξ ⅆ η \\ = \frac{{J}_{1} ( \frac{2 π {ρ}_{o} r}{λ f} )}{\frac{π {ρ}_{o} r}{λ f}}\end{matrix} \qquad ( 7 )$$

In formula (7), J₁(x) is a first-kind Bessel function, r=√(x²+y²).

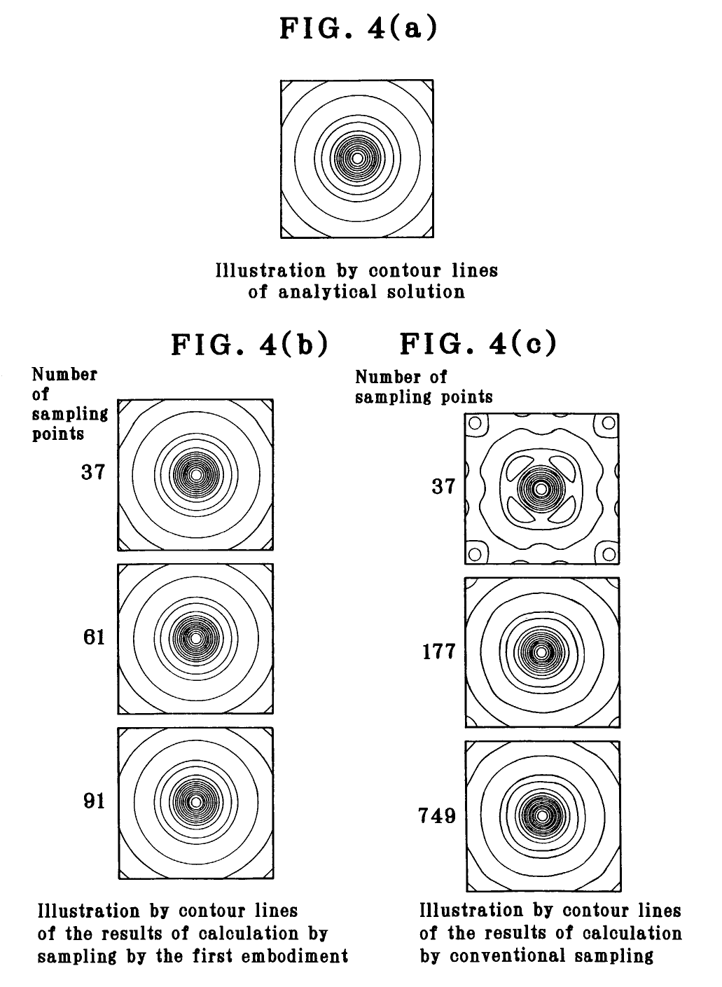

From a comparison of the results of calculation found by the sampling method of the instant embodiment with those found by a conventional sample method with respect to the diffraction pattern Eₒ formed at the focal plane 6, it is understood that, as shown in FIGS. 4(a) to 4(c), the sampling method of the instant embodiment (FIG. 4(b)) can give the results of calculation with higher precision than in the conventional sampling method (FIG. 4(x)), so that the rotational symmetry of an analytical solution (FIG. 4(a)) can be reproduced with a more reduced number of sampling points. In the sampling method of the instant embodiment, the rotationally symmetric results of calculation, which are indiscernible from the analytical solution, are obtained with as small as 61 sampling points. In the conventional sampling method, on the other hand, the results of calculation are apparently out of rotational symmetry even with as many as 749 sampling points.

While the instant embodiment is directed to the simulation method using an electric field alone, it is understood that similar calculus may be applied to a magnetic field, as can be seen from well-known Maxwell's equations expressing the symmetry of an electric field and a magnetic field.

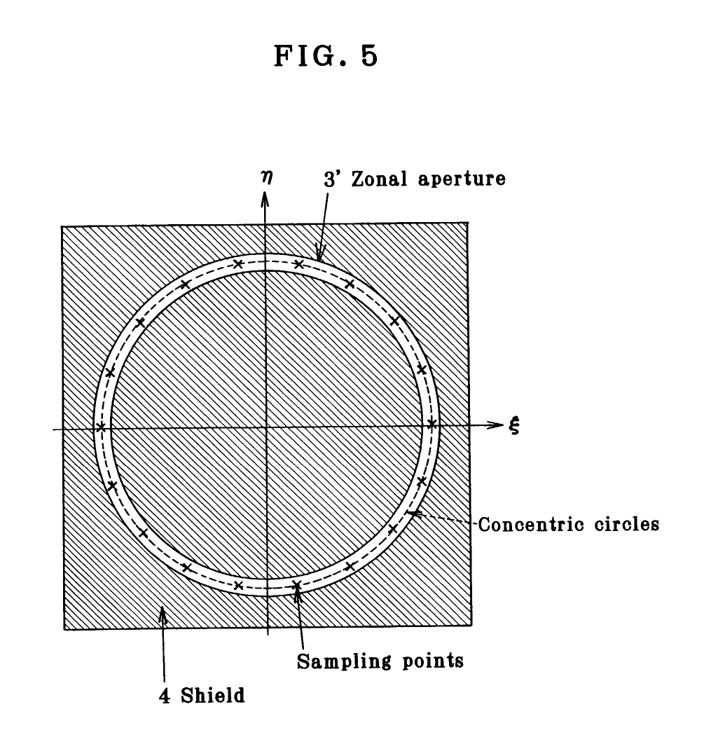

In the second embodiment of the electromagnetic field simulation method of the invention, the circular aperture in the first embodiment is replaced by a zonal aperture 3′ having an outer-to-inner diameter ratio (zone ratio) of 10:9. In the sampling method according to this embodiment, sampling points are equally spaced on one concentric circle in the zonal aperture 3′, as indicated by symbols × in FIG. 5. In a conventional sampling method, on the other hand, points defined by lattice points collocated at an entrance pupil in a tetragonal lattice form and found within a zonal aperture 3′ are used as sampling points.

No account is given of the simulation means of the instant embodiment because of being similar to that in the first embodiment.

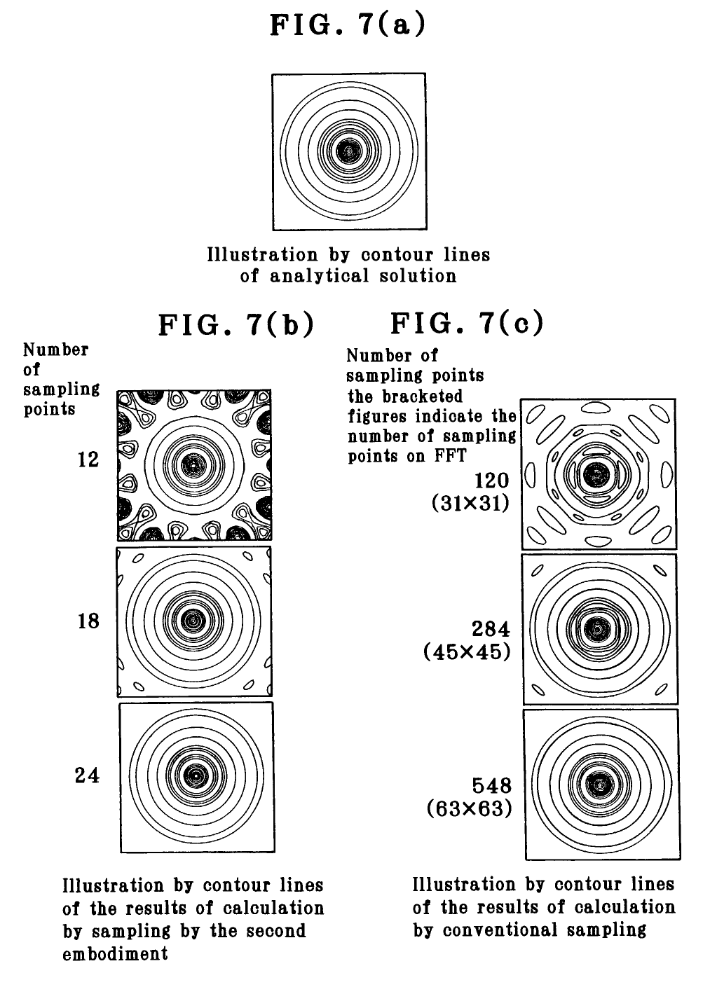

As shown in FIGS. 7(a) to 7(c), the sampling method of the instant embodiment (FIG. 7(b)) gives the results of calculation equivalent to an analytical solution (FIG. 7(a)) with sampling points much more reduced than in the conventional sampling method (FIG. 7(c)).

As can be appreciated form the foregoing explanations, the electromagnetic field simulation method of the invention, and the system and recording medium for the same enable diffraction calculations to be performed with higher precision yet with a more reduced number of sampling points than in the prior art.

What we claim is:

1. An electromagnetic field simulation method for calculating an electric or magnetic field at a different site from an electric or magnetic field sampled in an aperture, characterized in that sampling points are collocated according to a collocating rule having non-translation symmetry.

2. The electromagnetic field simulation method according to claim 1, characterized in that said sampling points are collocated on concentric circles of equidistant radii.

3. The electromagnetic field simulation method according to claim 2, characterized in that said sampling points are equally spaced on said concentric circles with a number of division proportional to the radii of said concentric circles.

4. The electromagnetic field simulation method according to claim 3, characterized in that said sampling points are distributed on said concentric circles at a space substantially equal to a distance between adjacent concentric circles.

5. The electromagnetic field simulation method according to claim 4, characterized in that said sampling points are distributed on said concentric circles at an equal space in a multiple of 6.

6. An electromagnetic field simulation system for calculating an electric or magnetic field at a different site from an electric or magnetic field sampled in an aperture, characterized in that sampling points are collocated according to a collocating rule having non-translation symmetry.

7. The electromagnetic field simulation system according to claim 6, characterized in that said sampling points are collocated on concentric circles of equidistant radii.

8. The electromagnetic field simulation system according to claim 7, characterized in that said sampling points are equally spaced on said concentric circles with a number of division proportional to the radii of said concentric circles.

9. The electromagnetic field simulation system according to claim 8, characterized in that said sampling points are distributed on said concentric circles at a space substantially equal to a distance between adjacent concentric circles.

10. The electromagnetic field simulation system according to claim 9, characterized in that said sampling points are distributed on said concentric circles at an equal space in a multiple of 6.

11. A recording medium having an image-formation or electromagnetic field simulation program recorded therein for allowing a calculating machine to calculate an electric or magnetic field at a different site from an electric or magnetic field sampled in an aperture, characterized in that sampling points are collocated according to a collocating rule having non-translation symmetry.

12. The recording medium having an electromagnetic field simulation program according to claim 11, characterized in that said sampling points are collocated on concentric circles of equidistant radii.

13. The recording medium having an electromagnetic field simulation program according to claim 12, characterized in that said sampling points are equally spaced on said concentric circles with a number of division proportional to the radii of said concentric circles.

14. The recording medium having an electromagnetic field simulation program according to claim 13, characterized in that said sampling points are distributed on said concentric circles at a space substantially equal to a distance between adjacent concentric circles.

15. The recording medium having an electromagnetic field simulation program according to claim 14, characterized in that said sampling points are distributed on said concentric circles at an equal space in a multiple of 6.
